(19) United States
(12) Patent Application Publication
(10) Pub. No.: US 2015/0211958 A1
(43) Pub. Date: Jul. 30, 2015

(54) SYSTEMS AND METHODS FOR INSPECTION OF SEALS

(71) Applicant: NESTEC S.A., Vevey (CH)

(72) Inventors: Jan Bruecklmeier, Dublin, OH (US); Mathew Goldman, Powell, OH (US); Gregory Schnurstein, Dublin, OH (US)

(21) Appl. No.: 14/418,532

(22) PCT Filed: Jul. 25, 2013
(86) PCT No.: PCT/EP2013/065730

§ 371 Date: Jan. 30, 2015

Related U.S. Application Data
(60) Provisional application No. 61/680,339, filed on Aug. 7, 2012.

(51) Int. Cl. G01M 3/38; G01B 15/00; G01B 11/14; G01M 3/32; G01B 11/26

(52) U.S. Cl. CPC G01M 3/38; G01M 3/32; G01B 11/26; G01B 11/14; G01B 15/00

(57) ABSTRACT

Systems and methods for inspecting seals for leaks are disclosed herein. In a general embodiment, the present disclosure provides a seal inspection system including: a closure threadingly attached to a container, each of the closure and the container including a mark; at least one camera positioned to detect the mark on the closure and the mark on the container; and a computer including a processor configured to calculate at least one of 1) an angle between the mark on the container and the mark on the closure, or 2) a distance between the mark on the container and the mark on the closure and determine whether the angle or the distance meets a reference value.

### BACKGROUND

The present disclosure relates generally to systems and methods for inspecting seals. More specifically, the present disclosure relates to systems and methods for inspecting seals for threaded closures.

Currently, to detect a leak in a bottle having a closure, a vision system is used to check the height of the closure in relation to a neck ring or bottom of the bottle as it sits on a conveyor belt. Another form of inspection is to look at how much light passes between the neck ring of the container and the closure and measure pixels from a display to measure the space or distance between the closure and the neck ring. While the current vision systems inspect every container, they can only find minor or major defects and not fine defects. The problem with these current inspection systems is that often times, a closure will be a “leaker” even if no height or space difference is detected, or the tolerance of an affordable vision system is higher than the tolerance of a seal versus no seal.

An alternative method of leak detection is squeeze/pressure or squeeze/headspace measurement detection systems. These methods require an additional piece of equipment to add to an assembly or production line thereby necessitating more capital and operational costs. A number of these systems also do not inspect every container.

### SUMMARY

The present disclosure relates to systems and methods for inspecting seals between closures and containers for leaks. In a general embodiment, the present disclosure provides a seal inspection system including: a closure threadingly attached to a container, each of the closure and the container including a mark; at least one camera positioned to detect the mark on the closure and the mark on the container; and a computer including a processor configured to calculate at least one of 1) an angle between the mark on the container and the mark on the closure, or 2) a distance between the mark on the container and the mark on the closure and determine whether the angle or the distance meets a reference value.

In an alternative embodiment of the system, one or more of the marks of the closure and/or one or more of the marks of the container are detectable by at least one of a laser beam, an x-ray or an ultra-violet light. In this system, one or more lasers, x-ray emitters and/or ultra-violet light emitters are positioned to emit toward the closure and the container. One or more suitable sensors are then appropriately positioned (e.g., in a configuration similar to the cameras) to detect the one or more of marks of the closure and/or one or more of marks of the container when the laser beam, x-ray or ultra-violet light is emitted. A computer including a processor is configured to calculate at least one of 1) an angle between the mark on the container and the mark on the closure, or 2) a distance between the mark on the container and the mark on the closure and determine whether the angle or the distance meets a reference value.

In any embodiments of the systems described herein, the container can be designated as a non-leaker if the angle or distance meets or exceeds the reference value. In addition or alternatively, the container can be designated as a leaker if the angle or distance does not meet the reference value.

In any embodiments of the systems described herein, the closure can include a threaded portion that is threadingly attached to a threaded portion of the container.

In any embodiments of the systems described herein, the mark on the container and the mark on the closure can be detected by the same camera. The camera, when viewing the closure and the container, can be placed at a non-horizontal position with respect to a vertical position of the closure and the container.

In any embodiments of the systems described herein, the mark on the container can be at least one of a notch or a protrusion. Similarly, the mark on the closure can be at least one of a notch or a protrusion.

In any embodiments of the systems described herein, the mark on the closure can be a point on a graphic of the closure. Similarly, the mark on the container can be a point on a graphic of the container.

In any embodiments of the systems described herein, the closure and the container can be part of an assembly line of closures attached to containers.

In an alternative embodiment, the present disclosure provides a method for inspecting a seal. The method comprises detecting a mark on a container; detecting a mark on a closure attached to the container; and calculating at least one of 1) an angle between the mark on the container and the mark on the closure, or 2) a distance between the mark on the container and the mark on the closure to determine whether the angle or the distance meets a reference value.

In another embodiment, the present disclosure provides a method for inspecting a seal. The method comprises emitting at least one of a laser, an x-ray or an ultra-violet light on a closure attached to a container; detecting a mark on a container and a mark on the closure from the emitted laser, x-ray or ultra-violet light; and calculating at least one of 1) an angle between the mark on the container and the mark on the closure, or 2) a distance between the mark on the container and the mark on the closure to determine whether the angle or the distance meets a reference value.

In any embodiments of the methods described herein, the method can further comprise designating the container as a non-leaker if the angle or distance meets or exceeds the reference value. In addition or alternatively, the method can further comprise designating the container as a leaker if the angle or distance does not meet the reference value.

In any embodiments of the methods described herein, the closure can include a threaded portion that is threadingly attached to a threaded portion of the container.

In any embodiments of the methods described herein, the mark on the container and the mark on the closure can be detected by at least one camera. In addition or alternatively, the mark on the container and the mark on the closure can be detected by the same camera. The camera, when viewing the closure and the container, can be place at a non-horizontal position with respect to the position of the closure and the container.

In any embodiments of the methods described herein, the mark on the container can be at least one of a notch or a protrusion. Similarly, the mark on the closure can be at least one of a notch or a protrusion.

In any embodiments of the methods described herein, the mark on the closure can be a point on a graphic of the closure. Similarly, the mark on the container can be a point on a graphic of the container.

An advantage of the present disclosure is to provide improved systems for detecting leaks from a closure of a container.

Another advantage of the present disclosure is to provide improved methods for detecting leaks from a closure of a container.

Yet another advantage of the present disclosure is to provide a packaging including a closure attached to a container for materials that prevents or minimizes potential leaks during and after manufacturing of the packaging.

Additional features and advantages are described herein, and will be apparent from, the following Detailed Description and the figures.

### BRIEF DESCRIPTION OF THE FIGURES

FIG. 1 is seal inspection system having cameras along a horizontal plane in an embodiment of the present disclosure.

FIG. 2 is a seal inspection system having cameras along a vertical plane in an embodiment of the present disclosure.

FIG. 3 is a close up perspective view of a closure having marks and a neck of a container having marks in an embodiment of the present disclosure.

FIG. 4 is a close up perspective view of a closure having marks and a neck of a container having marks in an embodiment of the present disclosure.

### DETAILED DESCRIPTION

The present disclosure relates to sealing technology. More specifically, the present disclosure relates to systems and methods for inspecting seals for threaded closures. The inspection systems described herein provide a visual measurement of designated marks on every container to assess any fine defects of a seal between each closure and container.

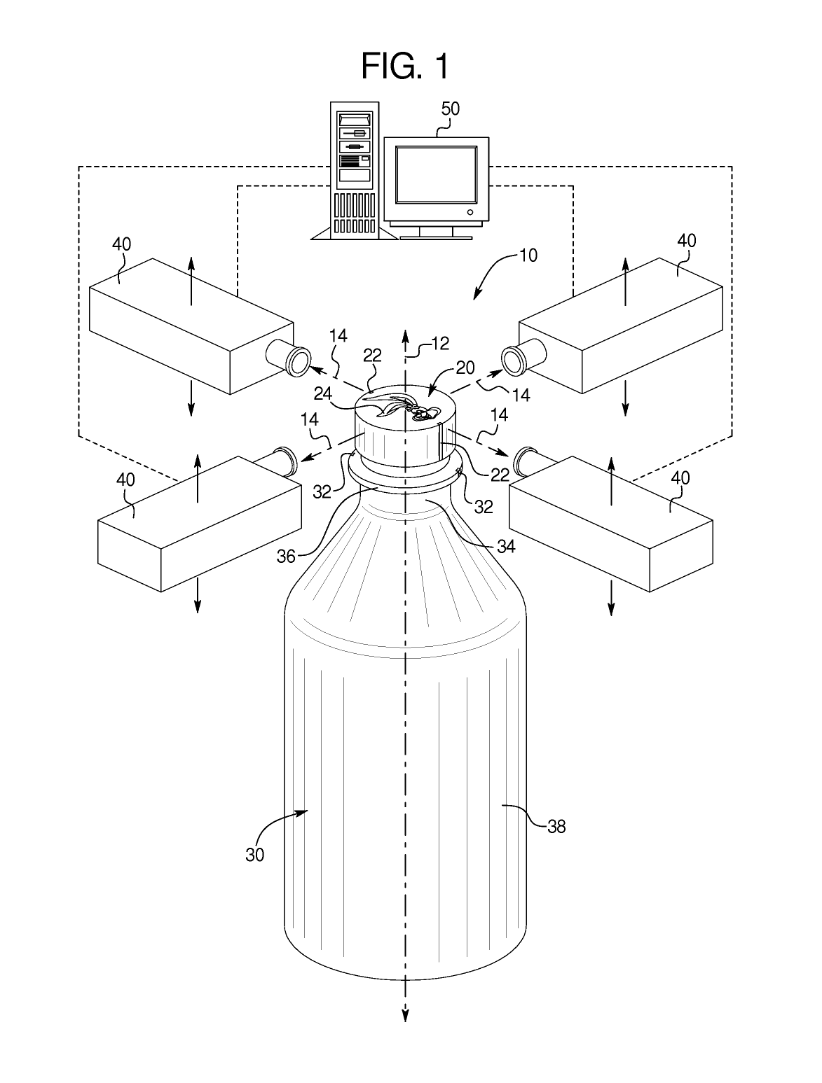

As shown in FIG. 1, the present disclosure provides a seal inspection system 10 having a closure 20 attached to a container 30. Closure 20 can be threadingly attached to container 30. Closure 20 can be any suitable covering for a container such as a cap, lid, cover, stopper, etc., for sealingly closing the container, for example, to prevent leakage of a product in the container. Container 30 can be any suitable storage device such as a bottle, beaker, can, canteen, capsule, carton, jug, pouch, package, receptacle, tank, vessel, vial, etc., for holding a substance or product. In an embodiment, closure 20 includes a threaded portion that is threadingly attached to a threaded portion of container 30. Closure 20 and container 30 can be any suitable size or shape as long as they are compatible with one another (i.e., the closure can be used to sealingly close the container).

Each of closure 20 and container 30 include one or more marks 22 and 32, respectively. As shown in FIG. 1, marks 22 on closure 20 can be in the form of one or more indentations, protrusions or notches on a surface of closure 20. In another embodiment, the mark can be a specific point or area on a graphic 24 of closure 20. Marks 32 on container 30 can be in the form of one or more indentations, protrusions or notches on container 30. For example, marks 32 can be on a rim 36 surrounding a neck 34 of container 30. In an alternative embodiment, marks 32 can be on any surface of container 30 including body 38.

As further shown in FIG. 1, one or more cameras 40 are used for seal inspection. Cameras 40 are positioned to detect the one or more marks 22 on closure 20 and the one or more marks 32 on container 30, for example, as container 30 passes cameras 40 along an assembly line or conveyor belt. As seen in FIG. 1, one or more cameras 40 can be placed along the same horizontal plane (e.g., same as plane 14) around vertical axis 12 and focused on marks 22 of closure 20 and marks 32 of container 30 at varying degrees from the vertical axis. It should be appreciated that cameras 40 can be positioned at any horizontal plane height and do not need to be positioned on the same horizontal plane. Cameras 40 can also be place at any suitable proximity or distance with respect to each other and closure 20 and container 30. In addition, at whatever horizontal plane cameras 40 are placed on, they can be tilted so that they can identify or detect the one or more marks 22 on closure 20 and the one or more marks 32 on container 30.

The one or more cameras 40 can be connected to a computer 50 using any suitable connection (e.g., wired, wireless). Computer 50 includes a processor configured to calculate at least one of 1) an angle between the mark on the container and the mark on the closure (e.g., with respect to a vertical or a horizontal axis), and/or 2) a distance between the mark on the container and the mark on the closure and determine whether the angle or the distance meets a reference value. In one example, the one or more marks 22 on closure 20 and the one or more marks 32 on container 30 are located, a line is drawn between them and a measurement is taken. Based on the length of this line and its angle, parameters for tolerance would be set up as part of the inspection system for a pass or fail determination. In this regard, container 30 having closure 20 can be designated as a non-leaker if the angle or distance meets or exceeds the reference value. It should be appreciated that the reference value as used herein can refer to a single value or a plurality of values that make up an acceptance range (e.g., designations as a leaker or non-leaker can be determined if distance or angles are lower or higher than the acceptance range). Container 30 having closure 20 can be designated as a leaker if the angle or distance does not meet the reference value.

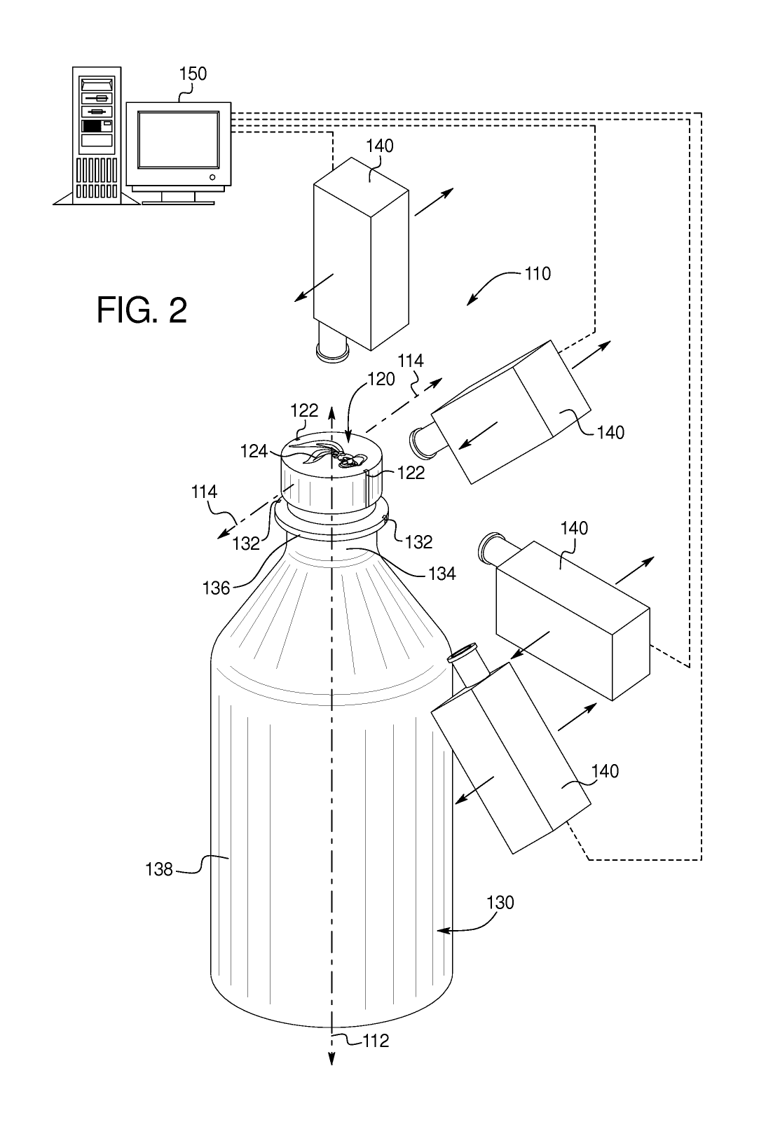

In another embodiment shown in FIG. 2, the present disclosure provides a seal inspection system 110 having a closure 120 attached to a container 130. Closure 120 can be threadingly attached to container 130. Each of closure 120 and container 130 can include one or more marks 122 and 132, respectively. As shown in FIG. 2, marks 122 on closure 120 can be in the form of one or more indentations, protrusions or notches on a surface of closure 120. In another embodiment, the mark can be a specific point or area on a graphic 124. Marks 132 on container 130 can be in the form of one or more indentations, protrusions or notches on container 130. For example, marks 132 can be on a rim 136 surrounding a neck 134 of container 130. In an alternative embodiment, marks 132 can be on any surface of container 130 including body 138.

As further shown in FIG. 2, one or more cameras 140 are positioned to detect the one or more marks 122 on closure 220 and the one or more marks 132 on container 130. As seen in FIG. 2, one or more cameras 140 are placed along the same vertical plane (e.g., with respect to vertical axis 112) and focused on marks 122 of closure 120 and marks 132 of container 130 at varying degrees from horizontal axis 114. It should be appreciated that cameras 140 can be positioned at any suitable vertical plane and angle with respect to horizontal axis 114. Cameras 140 can also be place at any suitable proximity or distance with respect to each other and closure 120 and container 130. In addition, at whatever vertical plane or angle cameras 140 are placed on, they can be tilted so that they can identify or detect the one or more marks 122 on closure 220 and the one or more marks 132 on container 130.

The one or more cameras 240 can be connected to a computer 150 using any suitable connection (e.g., wired, wireless). Computer 150 includes a processor configured to calculate at least one of 1) an angle between the mark on the container and the mark on the closure (e.g., with respect to a vertical or a horizontal axis), and/or 2) a distance between the mark on the container and the mark on the closure and determine whether the angle or the distance meets a reference value. In this regard, container 130 having closure 120 can be designated as a non-leaker if the angle or distance meets or exceeds the reference value. Container 130 having closure 120 can be designated as a leaker if the angle or distance does not meet the reference value.

With an angular measurement according to one embodiment, the inspection system working in an angle of anywhere between 0 degrees to 180 degrees from the vertical plane as shown in FIGS. 2 and 360 degrees on the horizontal plane, as shown in FIG. 1, can identify marks on the closure and the container. The inspection system will then find the center point of the closure on the horizontal plane. The inspection system will calculate the angular change based on the marks' reference to the center point of the closure.

With a distance measurement according to another embodiment, the inspection system working in an angle of anywhere between 0 degrees to 180 degrees from the vertical plane as shown in FIGS. 2 and 360 degrees on the horizontal plane, as shown in FIG. 1, will identify marks on the closure and the container. The inspection system will draw a line between the mark on the container to the nearest mark on the closure, or vice versa, tangentially to the outer radius of the closure. The inspection system will calculate the distance of that line.

In any embodiments of the systems and methods described herein, the reference value can be a predetermined value or range of values that is specifically designated for a particular closure, container or combination thereof. In this regard, closure, container or combination thereof may have a unique reference value to be sufficiently “leak proof.” The reference values can be theoretically calculated or measured or determined via leak testing of the closure, container or combination thereof. A tolerance value or range can be built into the reference values and be based on designated parameters depending on the types of closures and/or containers evaluated. The reference values can be listed and stored as part of a computer program or software that can be utilized with the manufacture and assembly of products having closures and containers.

Along these lines, in an embodiment, the present disclosure provides a computer readable medium containing program instructions for inspecting seals between a closure and a container, wherein execution of the program instructions by one or more processors of a computer system causes the one or more processors to carry out the steps of: detecting a mark on a container; detecting a mark on a closure attached to the container; and calculating at least one of 1) an angle between the mark on the container and the mark on the closure, or 2) a distance between the mark on the container and the mark on the closure to determine whether the angle or the distance meets a reference value. The reference value can be a predetermined value derived from theoretically calculated or leak testing results of a plurality of closures, containers and combinations thereof.

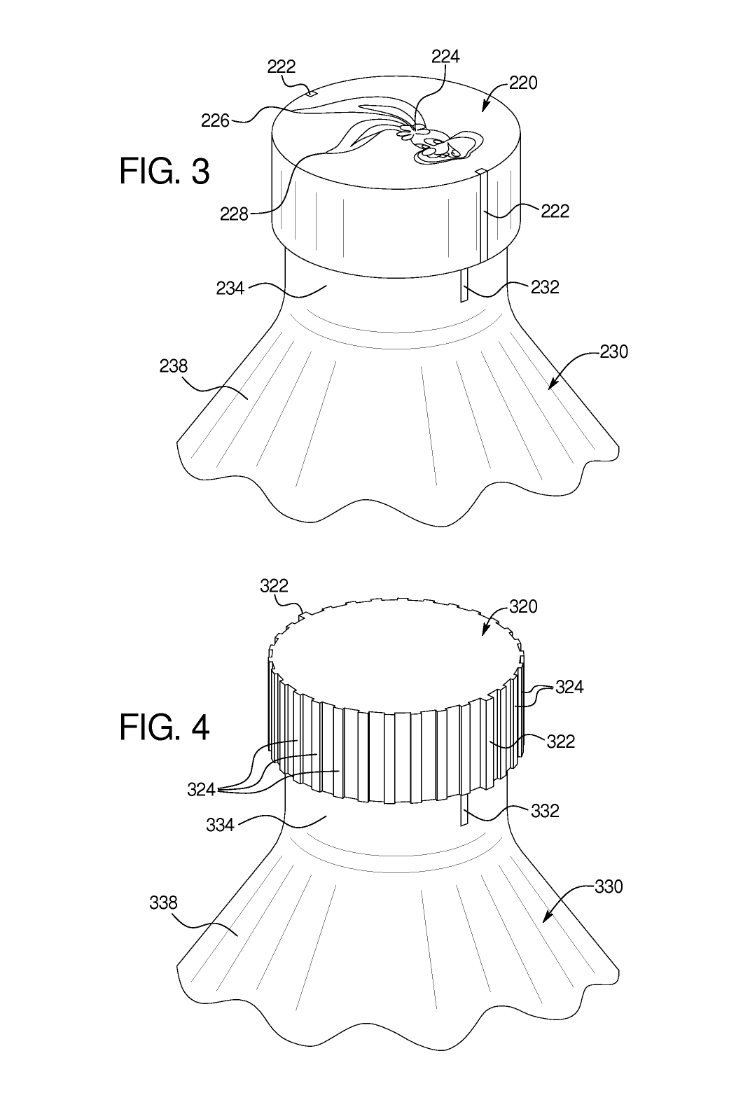

Alternative embodiments of the marks on the closure and containers are seen in FIGS. 3-4. In FIG. 3, closure 220 can include marks 222 as indentations on closure 220. Alternatively, or in addition to, the mark can be tips 226 and 228 of the ear of a rabbit figure 224 as shown in FIG. 3 although the marks can be any designated point on rabbit figure 224. In this regard, any variety of figures, symbols, indicia or insignias can be used in a similar manner. Container 230 having a body 238 can include one or more indentations 232 on neck 234 without the need for a rim.

FIG. 4 shows a closure 320 having a knurl pattern or ridges 324 for easier gripping and twisting by a user. In this configuration, one or more elongated protrusions 322 can be used to represent the mark. Container 330 having a body 338 can include one or more indentations 332 on neck 334 without the need for a rim.

In alternative embodiments, one or more cameras can be placed at any suitable combination of different horizontal planes and at different vertical planes with differing degrees from the vertical axis and horizontal axis as long as the cumulative effect of the cameras is to be able to detect at least 1) an angle between the mark on the container and the mark on the closure, and/or 2) a distance between the mark on the container and the mark on the closure and determine whether the angle or the distance meets a reference value.

Any suitable camera can be used to identify and measure the marks of the closure and the marks of the container in any of the systems and methods described herein. In addition, any suitable number of cameras can be used. For instance, a single camera can be used if it is in a suitable position or location that is capable of detecting at least 1) an angle between the mark on the container and the mark on the closure, and/or 2) a distance between the mark on the container and the mark on the closure to determine whether the angle or the distance meets a reference value. In this regard, the mark on the container and the mark on the closure are detected by the same camera.

The systems described herein can be incorporated as part of an assembly line of closures attached to containers. Before being released for further manufacturing or modification, the closures attached to each container can be examined using the systems described herein to determine whether the closures pass a leak inspection. Only closures that have been identified as non-leakers can be passed. Meanwhile closures identified has leakers can be removed from the assembly line and further tightened or disposed.

In another embodiment using any of the systems described herein, inspection systems based on image contrast may be used to determine placement and measurement of the marks. For example, sensor based systems using lasers can be used to scan the surface of the closures and the containers thereby finding the marks and relating rotational position of the closure in relation the container according to methods described herein. X-rays may also be used to detect areas of higher x-ray reflectivity and relate rotational position of the closure to the container. Finally, ultra-violet ink may be used as the marks with ultra-violet cameras relating rotational position of the closure with respect to the container.

In an embodiment, a specific method for inspecting a seal can include emitting at least one of a laser, an x-ray or an ultra-violet light on a closure attached to a container; detecting a mark on a container and a mark on the closure from the emitted laser, x-ray or ultra-violet light; and calculating at least one of 1) an angle between the mark on the container and the mark on the closure, or 2) a distance between the mark on the container and the mark on the closure to determine whether the angle or the distance meets a reference value. The container can be designated as a non-leaker if the angle or distance meets or exceeds the reference value. Alternatively, the container can be designated as a leaker if the angle or distance does not meet the reference value.

Closure 20 can be sized and shaped to fit with any suitable container 30. Container 30 is not limited to any particular size. The dimensions of closure 20 and container 30 can be such that they have identical or substantially similar peripheral shapes so as to make packaging 10 appear as a cohesive unit. The skilled artisan will appreciate that the dimensions of closure 20 and container 30 may vary as desired or in accordance with manufacturing specifications or in accordance with the size and shape of the consumable products contained therein.

Closure 20 is not limited to any particular shape or size, so long as closure 20 is capable of sealingly fitting to container 30 to prevent loss or contamination of a consumable product housed therein. The surface of closure 20 and/or container 30 can include any suitable gripping textures or portions. The gripping texture or portions may be, for example, a rough surface or dimple grips and may have a shape such as a circle, square, rectangle, triangle, quadrilateral, pentagon, hexagon, heptagon, octagon, nonagon, decagon, hexadecagon, icosagon, star, ellipse, semicircle, crescent, flower, or combinations thereof.

Closure 20 and/or container 30 can include any additional indicia or instructions printed on their surfaces. The indicia may include, for example, colors, numbers, letters, logos, advertisements, branding information, nutritional information, product information, manufacturer information, etc. The indicia may be printed on a pressure sensitive material, printed directly on closure 20 and/or container 30, printed on a removable closure, attached as a sticker, etc. The indicia may be placed on closure 20 and/or container 30 by a method such as embossing, debossing, printing, engraving, a sticker, or combinations thereof. The instructions can depict or describe, for example, how to serve or administer the contents of container 30.

Closure 20 and container 30 can be made from any suitable materials such as polymers, plastics or other synthetic materials. For example, closure 20 and/or container 30 can be made from a polyethylene material such as linear low density polyethylene or a suitable polypropylene.

Closure 20 and/or container 30 may be formed using conventional thermoforming or molding processes including, but not limited to, injection molding, injection blow molding and extrusion blow molding. Alternatively, closure 20 and/or container 30 may be manufactured from non-plastic materials including, but not limited to, cardboard, metal, styrofoam, etc.

In alternative embodiments, any suitable portion of closure 20 and/or container 30 can be either transparent or translucent so that a consumer can readily discern what types of products are housed therein. Alternatively, at least a portion of closure 20 and/or container 30 may be opaque. Closure 20 may be manufactured from a same or different material as container 30 and may be translucent while container 30 is opaque, or vice versa.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A seal inspection system comprising:
a closure threadingly attached to a container, each of the closure and the container comprising a mark;
at least one camera positioned to detect the mark on the closure and the mark on the container; and
a computer comprising a processor configured to calculate at least one of: an angle between the mark on the container and the mark on the closure, or a distance between the mark on the container and the mark on the closure, and determine whether the angle or the distance meets a reference value.

2. The system of claim 1, wherein the container is designated as a non-leaker if the reference value is met or exceeded.

3. The system of claim 1, wherein the container is designated as a leaker if the reference value is not met.

4. The system of claim 1, wherein the closure comprises a threaded portion that is threadingly attached to a threaded portion of the container.

5. The system of claim 1, wherein the mark on the container and the mark on the closure are detected by the same camera.

6. The system of claim 5, wherein the camera, when viewing the closure and the container, is positioned at a non-horizontal position with respect to a vertical position of the closure and the container.

7. The system of claim 1, wherein the mark on the container is at least one of a notch or a protrusion.

8. The system of claim 1, wherein the mark on the closure is at least one of a notch or a protrusion.

9. The system of claim 1, wherein the mark on the closure is a point on a graphic of the closure.

10. The system of claim 1, wherein the mark on the container is a point on a graphic of the container.

11. The system of claim 1, wherein the closure and the container are part of an assembly line of closures attached to containers.

12. A seal inspection system comprising:
a closure threadingly attached to a container, at least one of the closure and the container comprising a mark detectable by at least one detector selected from the group consisting of a laser beam, an x-ray and an ultra-violet light;
at least one emitter selected from the group consisting of a laser, an x-ray emitter or and an ultra-violet light emitter positioned to emit toward the closure and the container;
at least one sensor positioned to detect at least one of the mark on the closure or the mark on the container when the laser beam, x-ray or ultra-violet light is emitted; and
a computer comprising a processor configured to calculate at least one of an angle between the mark on the container and the mark on the closure, or a distance between the mark on the container and the mark on the closure, and determine whether the angle or the distance meets a reference value.

13. The system of claim 12, wherein the container is designated as a non-leaker if the reference value is met or exceeded.

14. The system of claim 12, wherein the container is designated as a leaker if the reference value is not met.

15. The system of claim 12, wherein the closure comprises a threaded portion that is threadingly attached to a threaded portion of the container.

16. The system of claim 12, wherein the mark on the container and the mark on the closure are detected by the same camera.

17. The system of claim 16, wherein the camera, when viewing the closure and the container, is positioned at a non-horizontal position with respect to a vertical position of the closure and the container.

18. The system of claim 12, wherein the mark on the container is at least one of a notch or a protrusion.

19. The system of claim 12, wherein the mark on the closure is at least one of a notch or a protrusion.

20. The system of claim 12, wherein the mark on the closure is a point on a graphic of the closure.

21. The system of claim 12, wherein the mark on the container is a point on a graphic of the container.

22. The system of claim 12, wherein the closure and the container are part of an assembly line of closures attached to containers.

23. A method for inspecting a seal, the method comprising:
detecting a mark on a container;
detecting a mark on a closure attached to the container; and
calculating at least one of an angle between the mark on the container and the mark on the closure, or a distance between the mark on the container and the mark on the closure, to determine whether the angle or the distance meets a reference value.

24. The method of claim 23 comprising designating the container as a non-leaker if the reference value is met or exceeded.

25. The method of claim 23 comprising designating the container as a leaker if the reference value is not met.

26. The method of claim 23, wherein the closure comprises a threaded portion that is threadingly attached to a threaded portion of the container.

27. The method of claim 23, wherein the mark on the container and the mark on the closure are detected by at least one camera.

28. The method of claim 23, wherein the mark on the container and the mark on the closure are detected by the same camera.

29. The method of claim 28, wherein the camera, when viewing the closure and the container, is positioned at a non-horizontal position with respect to a vertical position of the closure and the container.

30. The method of claim 23, wherein the mark on the container is at least one of a notch or a protrusion.

31. The method of claim 23, wherein the mark on the closure is at least one of a notch or a protrusion.

32. The method of claim 23, wherein the mark on the closure is a point on a graphic of the closure.

33. The method of claim 23, wherein the mark on the container is a point on a graphic of the container.

34. A method for inspecting a seal, the method comprising:
emitting at least one detector selected from the group consisting of a laser, an x-ray and an ultra-violet light on a closure attached to a container;
detecting a mark on a container and a mark on the closure from the emitted laser, x-ray or ultra-violet light; and
calculating at least one of an angle between the mark on the container and the mark on the closure, or a distance between the mark on the container and the mark on the closure, to determine whether the angle or the distance meets a reference value.

35. The method of claim 34 comprising designating the container as a non-leaker if the reference value is met or exceeded.

36. The method of claim 34 comprising designating the container as a leaker if the reference value is not met.

37. The method of claim 34, wherein the closure comprises a threaded portion that is threadingly attached to a threaded portion of the container.

38. The method of claim 34, wherein the mark on the container and the mark on the closure are detected by at least one camera.

39. The method of claim 34, wherein the mark on the container and the mark on the closure are detected by the same camera.

40. The method of claim 39, wherein the camera, when viewing the closure and the container, is positioned at a non-horizontal position with respect to the position of the closure and the container.

41. The method of claim 34, wherein the mark on the container is at least one of a notch or a protrusion.

42. The method of claim 34, wherein the mark on the closure is at least one of a notch or a protrusion.

43. The method of claim 34, wherein the mark on the closure is a point on a graphic of the closure.

44. The method of claim 34, wherein the mark on the container is a point on a graphic of the container.

45. A computer readable medium containing program instructions for inspecting seals between a closure and a container, wherein execution of the program instructions by one or more processors of a computer system causes the one or more processors to carry out the steps of:
detecting a mark on a container;
detecting a mark on a closure attached to the container; and
calculating at least one of an angle between the mark on the container and the mark on the closure, or a distance between the mark on the container and the mark on the closure, to determine whether the angle or the distance meets a reference value.
